(19) United States
(12) Patent Application Publication
(10) Pub. No.: US 2005/0099127 A1
(43) Pub. Date: May 12, 2005

(54) Light emitting panel module

(76) Inventors: Kuo-Ming Chen, Dasi Township (TW); Jong-Woung Kim, Dasi Township (TW)

Correspondence Address: Kuo-Ming Chen, P.O. Box No. 6-57, Junghe, Taipei, 235, TW

(21) Appl. No.: 10/704,700

(22) Filed: Nov. 12, 2003

(51) Int. Cl. H01J 1/62; H01J 17/16

(52) U.S. Cl. 313/634; 313/495

(57) ABSTRACT

A light emitting panel module utilized to provide a light emitting source for a back-lighted panel, and having a modularized structure. Upon vacuum pressing and molding under a high temperature, a sheet light emitting tube is formed thereof, and enables forming of a plurality of variant shapes according to requirements of actual practical applications. The light emitting tube is further adapted to provide uniform light color and long life usage having an upper panel and a lower panel, with the upper panel being formed as the light emitting tube from variant shape arrangements according to requirements of actual practical applications. The lower panel is bonded to the upper panel, thereby forming a sealed light emitting panel module. A space between the upper panel and the lower panel forms a hollow receptacle space, whereby providing filling of a noble gas therein, thus enhancing lifespan of the light emitting tube.

### BACKGROUND OF THE INVENTION

(a) Field of the Invention

The present invention relates to a light emitting panel module utilized to provide a light emitting source for a back-lighted panel, and more particularly to the light emitting panel module comprising an upper panel and a lower panel bonded together, which enables reducing degree of difficulty in manufacturing process, as well as enhancing degree of uniformity of light color when irradiating light.

(b) Description of the Prior Art

Accordingly, present image generation of a liquid crystal display employs light irradiated from a light emitting tube, which is then utilized to display the image on a back-lighted panel. In general, the light emitting tube utilized is a cold cathode tube, which is manufactured by employing a drawing out method. Referring to FIG. 1, which shows a conventional display back-lighted module 10 primarily constructed to include a back-lighted panel 101, and a light emitting tube 102. The light emitting tube 102 is configured at a rear of the back-lighted panel 101. Furthermore, a light emitting device 103 is usually configured at an extremity of the light emitting tube 102, and utilized for provision of a light source. Upon an electric current flowing, the light emitting device 103 emits light, and the light source thereupon is guided along the light emitting tube 102 enabling the entire light emitting tube 102 to illuminate, which then irradiates the back-lighted panel 101 and enables displaying of an image on the back-lighted panel 101 thereof. Referring to FIG. 1, which shows the conventional light emitting tube 102 as a singular light tube or a n-shaped light tube. During manufacture, the light emitting tube 102 is produced by a drawing out method, and owing to extreme meticulosity of the light emitting tube, extreme care is required during drawing out of the light emitting tube 102, because any problem occurring during the manufacturing process will result in flaws or cracks being produced in the light emitting tube 102. Thus, extreme difficulty in the manufacturing process of the light emitting tube 102 reflects correspondingly in high production costs. In addition, if shape of the light emitting tube 102 is of the n-shape type, a snake-shape or other variant type (for instance circular type or oval type), then degree of difficulty of manufacture is even more significantly heightened, because during process of drawing out or blowing process, If a special shape is required of the light emitting tube, then a procedure requiring bending of the light tube will certainly be necessary. For instance, if there is a requirement to manufacture the n-shape or snake-shape type of light emitting tube, curved sections of the light emitting tube often crack easily, and rate of flaws occurring in finished products is increased, and is undoubtedly a heavy burden on production costs.

Furthermore, the conventional light emitting tube, because of multiple layouts, results in a spacing occurring between each light emitting tube. If no consideration is given to calculating distance of this spacing, then a phenomenon will occur which results in non-uniform illumination being provided by the light emitting tubes. If the spacing between one light emitting tube and another light emitting tube is inappropriate, then may result in overlapping of light colors and thereby forming a particularly bright region or a situation may arise whereby a blurred shadow is formed because of overlapping of the light colors.

### SUMMARY OF THE INVENTION

In view of the fore-mentioned problems, a primary objective of the present invention is to provide a modularized light emitting tube, which enables manufacture of the light emitting tube by means of modularized structure production, thereby avoiding cracks or flaws from occurring when forming a singular light tube, and thus significantly reducing degree of difficulty in production and manufacture, while advancing production efficiency, and diminishing production of inferior goods. Furthermore, another objective of the present invention is to provide a light emitting panel module that effectively irradiates uniform light color, enabling a back-lighted panel to receive better uniform light color. Yet another objective of the present invention is to provide a light emitting tube that can be produced in variant shapes in accordance with actual practical requirements.

The light emitting panel module according to the present invention is of a modularized structure. Upon vacuum pressing and molding under a high temperature, a sheet light emitting tube is formed thereof, and a plurality of variant shapes can be formed according to requirements of actual practical applications. The light emitting panel module primarily comprises an upper panel and a lower panel, with the upper panel being formed as the light emitting tube from variant shape arrangements according to requirements of actual practical applications. The lower panel is bonded to the upper panel, thereby forming a sealed light emitting panel module. A spacing between the upper panel and the lower panel forms a hollow receptacle space, wherewith can be utilized to provide filling of a noble gas therein, thus enhancing lifespan of the light emitting tube.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a conventional display back-lighted panel.

FIG. 2 shows an elevational view according to the present invention.

FIG. 3 shows a cutaway view according to the present invention.

FIG. 4 shows a preferred embodiment (1) according to the present invention.

FIG. 5 shows a cross sectional view of another preferred embodiment (2) according to the present invention.

FIG. 6 shows a cross sectional view of yet another preferred embodiment (3) according to the present invention.

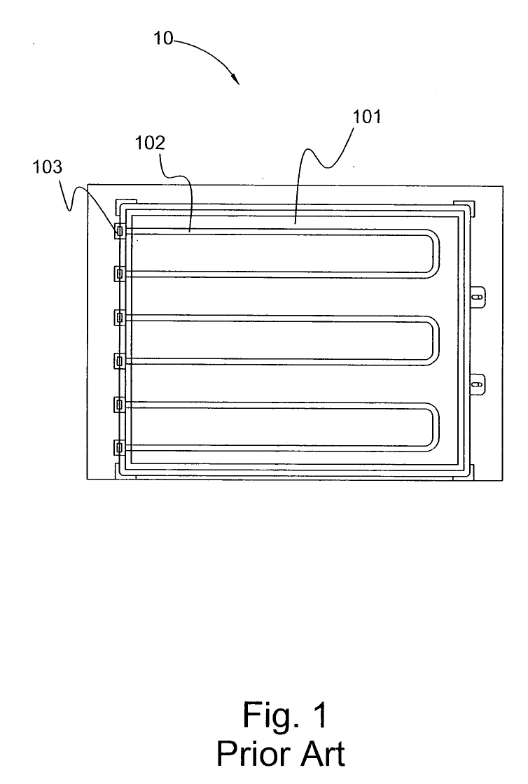

### DETAILED DESCRIPTION OF THE PREFERRED EMBODIMENTS

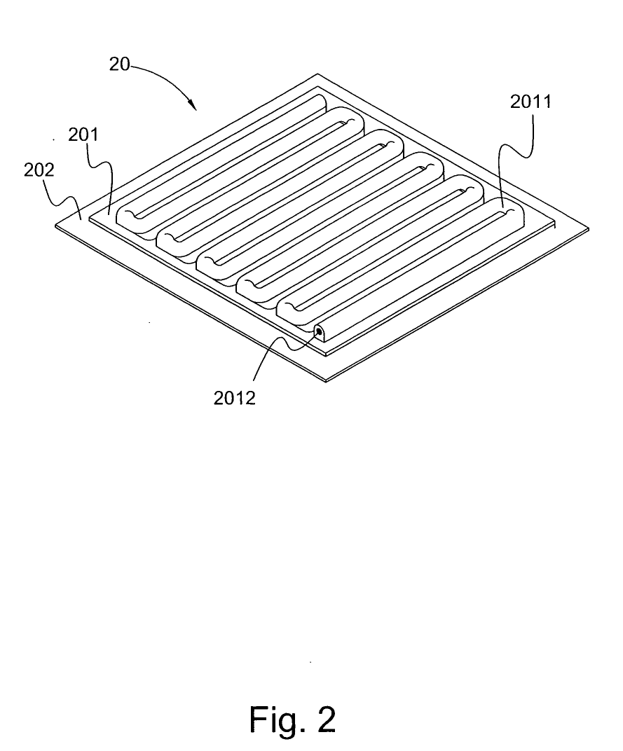

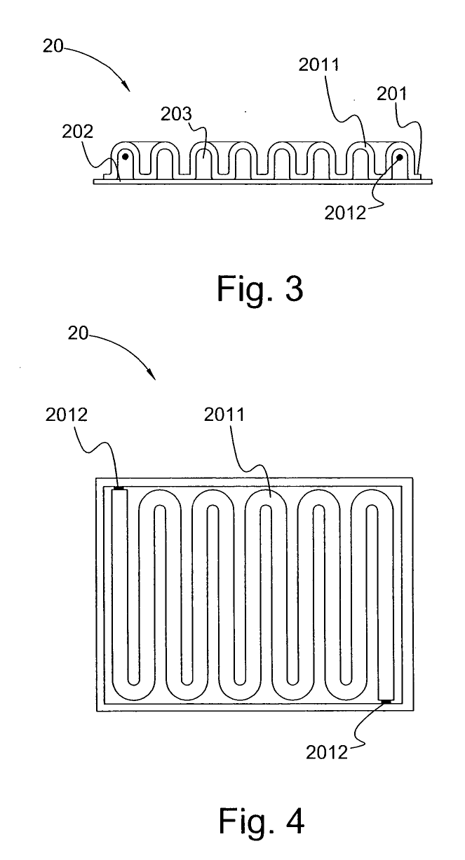

Referring to FIG. 2, which shows an elevational view of a light emitting panel module 2 according to the present invention. As FIG. 2 depicts, the light emitting panel module 2 is primarily constructed to include an upper panel 201, and a lower panel 202. A surface of the upper panel 201 is facially raised to form a sheet snake-shaped tube 2011. A light emitting device 2012 is configured at one end or both ends of the sheet snake-shaped tube 2011. The lower panel 202 and the upper panel 201 can be processed and bonded together by such means as vacuum pressing and molding under a high temperature. Upon bonding together the lower panel 202 and the upper panel 201, a spacing between the upper panel 201 and the lower panel 202 forms a hollow receptacle space 203 thereof (see FIG. 3). The hollow receptacle space 203 can be filled with a noble gas, therewith extending lifespan of a light emitting tube; also, upon a ray of light entering, a better luminescence reaction occurs. Furthermore, the receptacle space 203 also enables complete covering of the light emitting device 2012. In addition, a vertex edge of the receptacle space 203 (a base edge of the sheet snake-shaped tube 2011) can be smeared with a layer of fluorescent body in accordance with usage requirements. Referring to FIG. 4, which shows a preferred embodiment (1) of the light emitting panel module 20 according to the present invention comprising a back-lighted source for a back-lighted panel.

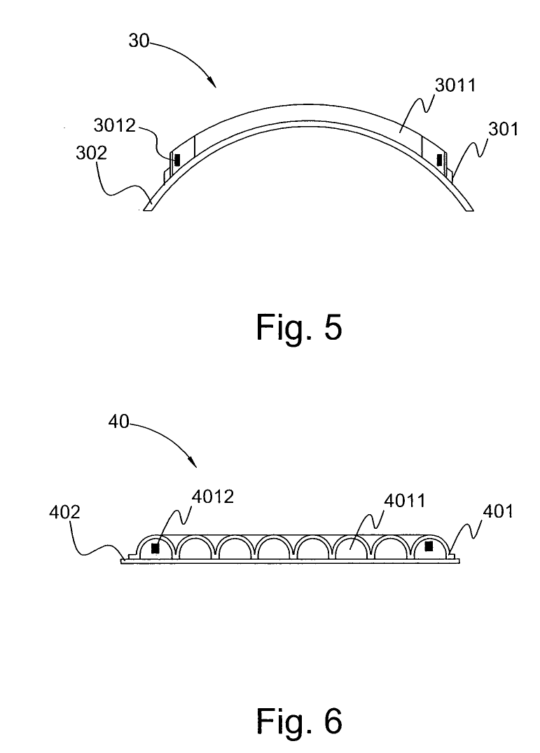

Referring to FIG. 5 which shows a second preferred embodiment (2) according to the present invention. The light emitting panel module 30 as depicted in FIG. 5 primarily comprises an upper panel 301, and a lower panel 302. As FIG. 5 depicts, the light emitting module 30 of the present invention is formed into an arc-shape in accordance with requirements for a special back-lighted panel light source for. A surface of the upper panel 301 is facially raised to form an arc-shaped tube 3011. Alight emitting device 3012 is configured on one end or both ends of the arc-shaped tube 3011, and utilized to provide a light source upon an electric current flowing through the light emitting module 30.

Referring to FIG. 6.which shows a third preferred embodiment (3) according to the present invention. The light emitting panel module 40 as depicted in FIG. 6 primarily comprises an upper panel 401, and a lower panel 402. A plane surface of the upper panel 401 is facially raised to form a light emitting tube 4011. A light emitting device 4012 is configured on one end or both ends of the light emitting tube 4011, and utilized to provide a light source upon an electric current flowing through the light emitting module 40. Furthermore, the surface of the light emitting tube 4011 can be molded into a circular form as depicted in FIG. 6 or other form types, such as a multi-angled form, a step ladder form, a triangular form, etc.

As mentioned above, the light emitting panel module of the present invention is manufactured so as to form a modularized structure, thereby reducing cracks and flaws occurring during production. According to the embodiments, following disclosures can be taken as evidence of certain advantages of the present invention:
(1) Modularized structure, enabling production of a plurality of light emitting tubes at one time, and therewith arrangement on an upper panel, and thereby improving on disadvantages of easy spoilage during manufacture of singular type light emitting tubes.
(2) Modularized production of the upper panel and a lower panel, which enables avoiding damage caused to singular light emitting tubes during drawing out production or blowing procedure.
(3) Enables molding of a curved light emitting tube structure directly on a surface of the upper panel.
(4) In accordance with actual practical requirements, enables configuring of variant modules to produce light emitting panel modules of different shapes and different arrangements.
(5) Enables production of an arc-shaped light emitting panel module.
(6) In accordance with actual practical requirements, enables adjustment of spacing of molding, allowing a more uniform light color to be emitted from the light emitting panel module.

In conclusion, the light emitting panel module of the present invention in accordance with embodiments disclosed, assuredly achieves the objective of providing manufacture of a light emitting tube by means of a modularized structure production, thereby avoiding cracks or flaws from occurring when forming a singular light tube, and thus significantly reducing degree of difficulty in production and manufacture, while advancing production efficiency, and diminishing production of inferior goods. Furthermore, achieves the objective of providing a light emitting panel module that effectively irradiates uniform light color, enabling a back-lighted panel to receive better uniform light color, as well as accomplishing the objective of providing a light emitting tube that can be produced in variant shapes in accordance with actual practical requirements.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A light emitting panel module, utilized to provide a light emitting source for a back-lighted panel, and comprising:
an upper panel, a plane surface of which is facially raised to form a snake-shaped tube;
a light emitting device, configured at one of the ends of the snake-shaped tube; and a lower panel, which can be bonded together with the upper panel to form the light emitting panel module, upon bonding together the lower panel and the upper panel, a spacing between the upper panel and the lower panel forms a hollow receptacle space thereof, which can be filled with a noble gas, as well as enabling complete covering of the light emitting device within the receptacle space.

2. The light emitting panel module as claimed in claim 1, wherein the snake-shaped tube comprises a plurality of vertical tubes and a plurality of curved tubes.

3. The light emitting panel module as claimed in claim 1, wherein the upper panel is formed by means of vacuum pressing and molding under a high temperature.

4. The light emitting panel module as claimed in claim 1, wherein the upper panel and lower panel are assembled together by means of high temperature bonding.

5. The light emitting panel module as claimed in claim 1, wherein an inner side surface of the upper panel is smeared with a fluorescent body.

6. A light emitting panel module, utilized to provide a light emitting source for a back-lighted panel, and comprising: the upper panel, the plane surface of which is facially raised to form a L-shaped tube;
the light emitting device, configured at one of the ends of the L-shaped tube; and the lower panel, which can be bonded together with the upper panel to form the light emitting panel module, upon bonding together the lower panel and the upper panel, the spacing between the upper panel and the lower panel forms the hollow receptacle space thereof, which can be filled with a noble gas, as well as enabling complete covering of the light emitting device within the receptacle space.

7. A light emitting panel module, utilized to provide a light emitting source for a back-lighted panel, and comprising:
the upper panel, which assumes an arc-shape, the arc surface is facially raised to form a light emitting tube;
the light emitting device, configured at one end of the light emitting tube; and the lower panel, which can be bonded together with the upper panel to form the light emitting panel module, upon bonding together the lower panel and the upper panel, the spacing between the upper panel and the lower panel forms the hollow receptacle space thereof, which can be filled with a noble gas, as well as enabling complete covering of the light emitting device within the receptacle space.

8. A light emitting panel module, utilized to provide a light emitting source for a back-lighted panel, and comprising: the upper panel, the plane surface of which is facially raised to form a light emitting tube, an outer surface of the light emitting tube assumes a multi-angled form;
the light emitting device, configured at one of the light emitting tube; and the lower panel, which can be bonded together with the upper panel to form the light emitting panel module, upon bonding together the lower panel and the upper panel, the spacing between the upper panel and the lower panel forms the hollow receptacle space thereof, which can be filled with a noble gas, as well as enabling complete covering of the light emitting device within the receptacle space.
